(19) United States
(12) Patent Application Publication
(10) Pub. No.: US 2010/0067830 A1
(43) Pub. Date: Mar. 18, 2010

(54) FLEXIBLE CONTAINER WITH ADHESIVE HANDLE

(75) Inventors: Simone Angiolini, Cairo Montenotte (IT); Andrea Della Torre, Busto Arsizio (IT)

Correspondence Address: HUSCH BLACKWELL SANDERS LLP, 190 CARONDELET PLAZA, SUITE 600, ST. LOUIS, MO, 63105-3441, US

(73) Assignee: ALCAN PACKAGING ARENZANO S.P.A., Arenzano (IT)

(21) Appl. No.: 12/522,771

(22) PCT Filed: Jan. 12, 2007
(86) PCT No.: PCT/IT2007/000024

§ 371 Date: Jul. 10, 2009

(51) Int. Cl. B65D 33/06; B31B 1/00; B31B 1/86

(52) U.S. Cl. 383/25; 493/267; 493/226

(57) ABSTRACT

A container suitable for being subjected to a filling and closing process, said container being formed from at least one flexible multi-layer laminated film and comprising at least one front panel and' at least one side panel sealed together, the length of said at least one side panel being shorter than the length of said at least one front panel, characterised in that said container comprises at least one device applied by means of adhesive to the outer surface of at least one of said side panels, said device being suitable for being partially raised to form a handle for the container itself. Said container is produced by means of an efficient and cost-effective method capable of being made with a limited number of steps, with no further step being necessary at the end of the production of the container to apply the handle to the container itself.

The present invention refers to a container made of a flexible multi-layer laminated film and equipped with an adhesive handle for its transportation and use, and to a method for producing such a container.

There are containers presently available on the market, for example preformed pouches, sacks or bags, made of multi-layer laminated films, used to package various types of product, for example granular, powdered, dried, and similar products, for food, agricultural or building uses.

Such containers are obtained from a multi-layer laminate film, through cutting, folding and sealing along the edges. They are generally made from films having the inner faces heat-sealable and obtained by subsequent folding and by carrying out transversal and longitudinal welding between overlapped parts of heat-sealable layers.

Such containers are typically used in filling equipment (also known as filling machines), which typically carry out the operations, in succession, of opening the top inlet of the container, introducing the filling nozzle, loading the product and finally sealing the container that is thus ready for transportation and distribution to the public.

The containers are frequently supplied with a handle to make easier the transportation and the pouring out of the product contained therein, when required. This is not strictly necessary for light and small containers, but it is very useful in the manipulation and transportation for bulky packs or those over a certain weight, for example for packages weighing over 1 Kg.

Generally, such handles are applied in the top part of the container near to the opening of the container itself, so as to make it easier to transport and, above all, to pour the product, when required. For example, U.S. Pat. No. 4,550,439 describes a container having a front panel connected to a rear panel along its edges, such a container further having a handle applied to a reinforcement arranged at one end of the panels.

However, when applied in such a part of the container, the handles take spaces which interfere with the filling process and, consequently, reduce the productivity of the typical operations described above that take place in the filling machines.

One of the solutions proposed in the prior art to avoid such a problem is to apply the handles to the container only after having completed the typical operations in the filling machines cited above. This solution makes the operations in the filling machines easier, since the spaces needed for such operations are left free; however, it does have the clear disadvantage of requiring a further step to apply the handle once the container has been filled, with considerable drawbacks in terms of cost and convenience.

Another solution is described in the European patent application no. 1,651,530 wherein a strip of material that acts as a handle is applied by welding or by adhesive to a container, such a strip being arranged in the top part of the container near to a side wall and connected to the container itself through its two ends. In particular, the strip that acts as a handle is arranged on the inner part of the front or rear panel of the container and is accessible from the outside through an opening applied to the panel itself. However, such a solution involves difficulties in terms of the production cycle in order to be able to apply such a strip to the container.

Recently, particular containers consisting of front panels and side panels sealed together (the latter being commonly indicated with the term “gusset”), so that the top end of the side panels is in an intermediate position between the bottom end and the top end of the front panels, have become widely used. The distance between the bottom end and the top end (hereafter indicated with the term “length”) of the side panels is therefore shorter than that of the front panels. Hereinbelow, for the sake of simplicity, such containers are indicated with the term “containers with reduced gusset”. At the end of the production process of a container with reduced gusset, such side panels are generally folded inwards.

The containers with reduced gusset have the undoubted advantage of substantially simplifying the filling and closing steps of the container. In particular, there are available on the market filling machines designed to use with high performances containers having such characteristics. However, such a shape of the side panels, generally folded in a V-shape towards the inside, makes more problematic the application of carrying handles using the most common solutions adopted for applying such a handle to standard containers (which do not have reduced gusset).

The technical problem at the basis of the present invention is to provide a container made from flexible material equipped with a handle, thus ensuring easy and handy transportation of the container, and that provides, at the same time, the requirements of not interfering with the production process of the container itself, thus without reducing its productivity, and of not interfering with the opening and filling process of the container in filling machines.

In accordance with a first aspect of the invention, this problem is solved by a container as defined in the attached claim 1.

In particular, a container suitable for being subjected to a filling and closing process, said container being formed from at least one flexible multi-layer laminated film and comprising at least one front panel and at least one side panel sealed together, the length of said at least one side panel being shorter than the length of said at least one front panel, characterised in that said container comprises at least one device applied by means of adhesive to the outer surface of at least one of said side panels, said device being adapted to be partially raised to form a handle for the container itself, is able to allow easy transportation of the container.

Moreover, since said device is positioned on one of the side panels, the front panels are free from obstacles and hindrances. Therefore, in this way, the filling and closing operations of the container in filling machinery are made easier, said operation involving devices generally present in the top part of the front panels of the container. Moreover, easy and handy transportation of the container is ensured, as well as an easier use, especially when the product is being poured.

For the purposes of the present description and of the following claims, by the term “container” it is meant a pouch, bag, sack, or any other robust container suitable for containing granular, powdered and similar products, such as for example food for people or animals, agricultural products such as soil or fertilisers, building products such as lime, cement and similar.

Preferably, the container of the present invention is made with a flexible multi-layer laminated film made with various materials selected according to requirements and applications such as, for example, paper, plastic, amorphous plastics, mono-oriented or bi-oriented, composite or lacquered, such as for example plastic films coated with organic or inorganic layers, co-extruded or other; metallic materials, such as for example aluminium foil, or mixtures thereof; biodegradable materials for producing containers that meet the requirements of current biodegradability and compostability standards (such as, for example, EN13432), or combinations thereof.

Among the plastic materials, polyesters, polyethylenes, polypropylenes, polyamides, polycarbonates, polyvinyl chlorides or mixtures thereof are preferred.

In this way, the container of the present invention has the advantage of using material; with good flexibility properties suitable for making it easier to be folded during the container manufacturing and with good gas barrier properties so as to ensure a suitable airtight seal.

Moreover, these materials have the advantage of ensuring suitable final mechanical properties to the container.

In this way, even in the case of handle failure, the integrity and air-tightness properties of the container itself are not jeopardised.

Preferably, the container of the present invention is made with a flexible multi-layer laminated film having a number of layers from 1 to 10, preferably from 2 to 7, with at least one layer placed between them suitable for adhesion promoting between one layer and the other, so as to make a laminate.

Preferably, an outer layer of said multi-layer container is suitable for being printed on by means of any printing technology known in the packaging industry such as, for example, rotogravure or flexography, so as to be able to reproduce, for example, distinctive marks, information about the product inside the container, manufacturer's name, and similar.

In this way, there is the advantage of being able to obtain containers in which such information is visible.

The containers of the present invention can have different shapes and functions.

Preferably, said container has at least two front panels and at least two side panels, the length of said two side panels being shorter than the length of said two front panels, said front and side panels all being sealed together so as to form the container.

More preferably, said container has two front panels, two side panels sealed together, the length of said two side panels being shorter than the length of said two front panels.

In a further embodiment, the container consists of at least one further bottom panel.

Preferably, said container can comprise further elements suitable for finishing the container and for providing the container itself with particular advantages, such as, for example, the facilitated opening system (i.e. “laser scoring”), the zip closing system, the slider, the labels, the technical solutions for dosing the content, and similar.

In particular, said container can comprise the facilitated opening system and/or the zip closing system, positioned in the top part of one of said front panels.

In this way, the container of the present invention can comprise both the handles and such devices that make it easier to open and close the container, since their respective positions on the container are as not to hinder one each other, unlike it occurs with containers known in the art.

Preferably, said device applied by means of adhesive to the outer surface of one of said side panels is suitable for taking up two distinct shapes, according to whether the container is in rest condition (device closed) or in operative condition (device open).

Preferably, in rest condition, i.e. when it is not necessary to hold the handle to move and/or transport the container more easily, said device adheres to the outer surface of the side panel on which said device is applied.

In this way, there are no problems of obstruction or hindrance, thus making easier, for example, to perform the filling, sealing, transportation and storage steps of the container.

Vice-versa, in operative conditions, i.e. when user needs to hold the handle to move and transport more easily the container, said device can be partially raised with respect to said outer surface of the side panel on which said device is applied.

In this way, the fingers of the hand are allowed to be inserted into the recess that has been created between said device suitable for being raised to form the handle and the outer surface of the side panel on which said device is applied.

Said device can be made, for example, with a plastic material having mechanical characteristics such as to resist to tearing during the raising step and the transportation of the container. Commonly used materials for this purpose are mono- or bi-oriented plastic films (such as, for example, polyamide, polypropylene, polyester, polyvinyl chloride), polyolefin films (co-extruded and/or mono-layer), rigid amorphous films (such as, for example, amorphous polyester, co-polyamides, polyester).

Preferably, such a device consists of a strip of such a multi-layer plastic material having a thickness of between 10 and 1000 micrometers.

The relatively low thickness of such a device allows the reduction of the space occupied by the device itself and, therefore, the reduction to the minimum of interferences and difficulties during the filling steps of the container, when it is inserted into said filling machines.

According to the present invention, said device is applied by means of adhesive to the outer surface of at least one of said side panels, so that said device is at the same time suitable for being partially raised to form a handle for the container itself. Said adhesion of the device to the panel can be obtained in various ways.

In a first embodiment of adhesion of the device to the panel, the device consists of a strip of such a plastic material having, for example, from 1 to 7 layers, wherein the bottom layer comprises at least an adhesion area suitable for adhering to the outer surface of the side panel of the container on which such a device is applied. The shape and size of said adhesion area are such as to ensure an adequate adhesion force between the device and the container, allowing it to be transported without any danger of device detachment from the container itself.

Preferably, in such a first embodiment, said bottom layer of the device contains at least one adhesive agent. Adhesive agents or glues that can be used for the purposes of the adhesion can be of any type chosen among those commonly used in the field of flexible packaging and of adhesive tapes, for example those known as mono-components or with many components, solvent-based, water-based or alcohol-based or without solvent, of the polyurethane, polyester, polyether or mixed type or even of the acrylic or epoxy type, able to cross-link by means of catalysts, temperature, light or other energy sources.

In such a first embodiment of adhesion of the device to the panel, the bottom layer of said device also comprises a non-adhesion area suitable for allowing said device to be partially raised in the operative step.

In an embodiment of said non-adhesion area, said bottom layer of the device has no adhesive agents in said non-adhesion area.

In another embodiment of said non-adhesion area, said bottom layer of the device comprises, in said non-adhesion area, at least one agent having release properties or chemical or physical incompatibility properties with regard to said adhesive agent.

In a second embodiment of adhesion of the device to the panel, the device consists of a strip of such a plastic material having, for example, from 1 to 7 layers, such as the one described previously with reference to the first embodiment of adhesion of the device to the panel, with the difference that such a bottom layer does not comprise non-adhesion areas. In this case, the outer surface of said side panel on which said device is applied comprises a non-adhesion area. Such a non-adhesion area can be obtained in accordance with any one of the embodiments of such a non-adhesion area as described previously, such as, for example, the presence on the outer surface of said side panel of at least one agent with release properties or chemical or physical incompatibility properties with regard to said adhesive agent present on the entire bottom layer of said device.

In this second embodiment of adhesion of the device to the panel, said device has an adhesive layer applied on the entire bottom layer that adheres to the outer surface of the side panel, with the exception of the non-adhesion areas.

In any one of said first and second embodiment of adhesion of the device to the panel, said at least one side panel can further comprise, on its outer surface, an adhesion promoter at said adhesion areas present on the device, so as to improve the adhesion between said side panel and the device suitable for forming the handle.

In this way, the adhesion force between the device and the container is increased, so as to make easier also the transport of containers weighing a lot, such as for example weighing over 4 Kg.

Adhesion promoters that can be used for the purposes of the present invention can be of any type among those commonly used in the field of flexible packaging and of adhesive tapes.

Whatever the embodiments of adhesion of the device to the panel, preferably, said non-adhesion area is situated between two of said adhesion areas so as to ensure, at the same time, the partial raising in the operative step of said device to form the handle and a better adhesion of the device to the container to avoid tears during such a raising step of the device to form the handle and during transportation of the container itself.

Said device suitable for constituting a handle can be of any geometric shape and size, defined based upon the desired design, the position of the handle itself and the level of resistance to tearing that one wishes to obtain. For example, the shape of the surface of said device can be obtained by curved lines and/or by straight lines, and from a combination thereof, which determine its perimeter.

Preferably, the non-adhesion area of said device consists of a surface having a length of between 3 and 30 centimetres and a width of between 0.5 and 10 cm. In the case in which said non-adhesion area is defined by curved lines, by length and width of such an area it is meant, respectively, the length and the width of the rectangular geometric shape enclosing said curved lines.

Preferably, said non-adhesion area has a length substantially equal to the average width of a man's hand (i.e. the distance between thumb and little finger) and a width shorter than the average size of the palm of a man's hand.

In this way, the surface of such a non-adhesion area is of a size such as to be able to be used as a handle.

More preferably, the with of said device in said non-adhesion area is lower than the width of said adhesion areas in order to make it even easier to grip the handle to transport the container.

Preferably, said container also comprises a device such as, for example, a tab or a guide suitable for making it even easier to raise such a non-adhesion area to form the handle.

In a second aspect, the invention refers to a method for producing a container such as the one previously described, such a method being defined as in the attached claim 7.

In particular, a method for producing said container, wherein said method comprises the steps of:

i) preparing at least one flexible multi-layer laminate;
ii) forming at least one front panel and at least one side panel from said at least one laminate;
iii) forming said container by sealing together said at least one front panel and said at least one side panel,
characterised in that before said step ii) begins, an adhesive device is applied to a portion of said at least one laminate suitable for forming said at least one side panel,
is able to produce said container efficiently, cost-effectively and with a small number of steps, providing good results in terms of productivity and performances in filling machinery.

In an embodiment, said adhesive device is applied to the laminate during step i).

In another embodiment, said device is applied in an intermediate step between the end of step i) and the beginning of step ii).

In an embodiment thereof, said step ii) further comprises the formation of at least one bottom panel.

The container obtained with said method is compatible with any industrial filling process of the container itself, without any needs for filling machine modifications.

In a preferred embodiment, said step i) comprises the steps of: a) preparing a main flexible multi-layer laminate, and b) preparing a secondary flexible multi-layer laminate.

Said steps can be carried out independently one each other, simultaneously or at different times.

Preferably, said step a) consists of preparing a reel of a main flexible multi-layer laminate obtained with the materials described above with reference to the container. Such a laminate is prepared, with known techniques, by overlapping one each other at least two layers, preferably at least three, so that the highest up positioned layer among said juxtaposed layers contributes to form, at the end of said step b), the outer surface of the front panel of the container and the lowest down positioned layer among said juxtaposed layers contributes to form the inner surface of the front panel of the container.

Preferably, said juxtaposed layers are coupled by means of technologies known in the packaging industry such as, for example, the use of coupling machines by solvent-based or solvent-free lamination, or by extrusion. Said juxtaposed layers are coupled with interposition of at least one adhesive layer between them, suitable for promoting the adhesion between said layers, so as to make such a laminate.

Similarly to what has been stated above with reference to step a), said step b) consists of preparing a reel of a secondary flexible multi-layer laminate obtained with the materials described above with reference to the container.

In an embodiment, said secondary flexible multi-layer laminate can comprise an adhesion promoter on its surface, suitable for increasing the adhesion force between the device and the container, so as to make it easy to transport even containers weighing a lot, such as for example weighing over 4 Kg.

Adhesion promoters that can be used for the purposes of the present invention can be, for example, functionalised layers, deposited through laying or spreading processes, or surface treatment as corona treatment or plasma treatment, such as to increase the adhesion and the compatibility of the surface of the panel to the adhesive agents or glues cited above.

In the preferred embodiment cited above in the presence of steps a) and b), step ii) comprises the steps of: c) forming at least one front panel from said main laminate, and d) forming at least one side panel from said secondary laminate.

In such a preferred embodiment, the method of the present invention has the advantage of having the step of application of such a device that involves just a part of the entire production cycle of the container, without having to make modifications to the remaining part of such a cycle and without any further costly application of the device at the end of the production of the container itself.

During step c), said main laminate is cut, folded and sealed along the edges by carrying out transversal and longitudinal welding between overlapping parts of heat-sealable layers to form at least one front panel of the container. Should heat-sealable materials not be used, said front panels are made by means of sealing systems using glue or adhesives.

In an embodiment, said main laminate can be used, as well as to form at least one front panel, also to form at least one bottom panel.

Similarly to what has been stated above with reference to step c), said secondary laminate is cut, folded and sealed along the edges to form at least one side panel of the container during step d).

Said device is applied to said secondary laminate through processes and apparatuses known in the art, such as, for example, label or adhesive hook applicators.

In an embodiment, said adhesive device is applied to said secondary laminate during step b).

In another embodiment, said adhesive device is applied to said secondary laminate in a process step following step b) and prior to step d).

In an embodiment, during step iii), said container is formed by sealing together two front panels and a bottom panel, obtained at the end of step c), and two side panels, obtained at the end of step d).

Such a step d) is independent from the aforementioned step c) and therefore step d) can take place before, during or after step c) is carried out. Due to the times linked to production, it is preferable that steps c) and d) be completed so as to reduce to the minimum the waiting times to begin the subsequent step iii).

At the end of the aforementioned steps of the production method of the present invention, a closed container is obtained, of substantially the same size and bulk as a container without a handle, and ready to be inserted into suitable filling machines of such containers. Such machines take care of the steps of opening the container, filling with the desired product and sealing the top part of the container.

At the end of the treatment in such filling machines, the container, filled and sealed, is ready to be stored and/or transported, using said handle.

Further characteristics and advantages of the container of the present invention and of the method for producing it shall become clearer from the following detailed description of some preferred embodiments thereof, given as non-limiting examples with reference to the attached drawings. In such drawings,

FIG. 1 is a schematic representation of a container in accordance with the present invention;

FIG. 2 is a side view of a device suitable for forming a handle of a container of the present invention, in rest condition;

FIG. 3 is a side view of a device suitable for forming a handle of a container of the present invention, in operative condition;

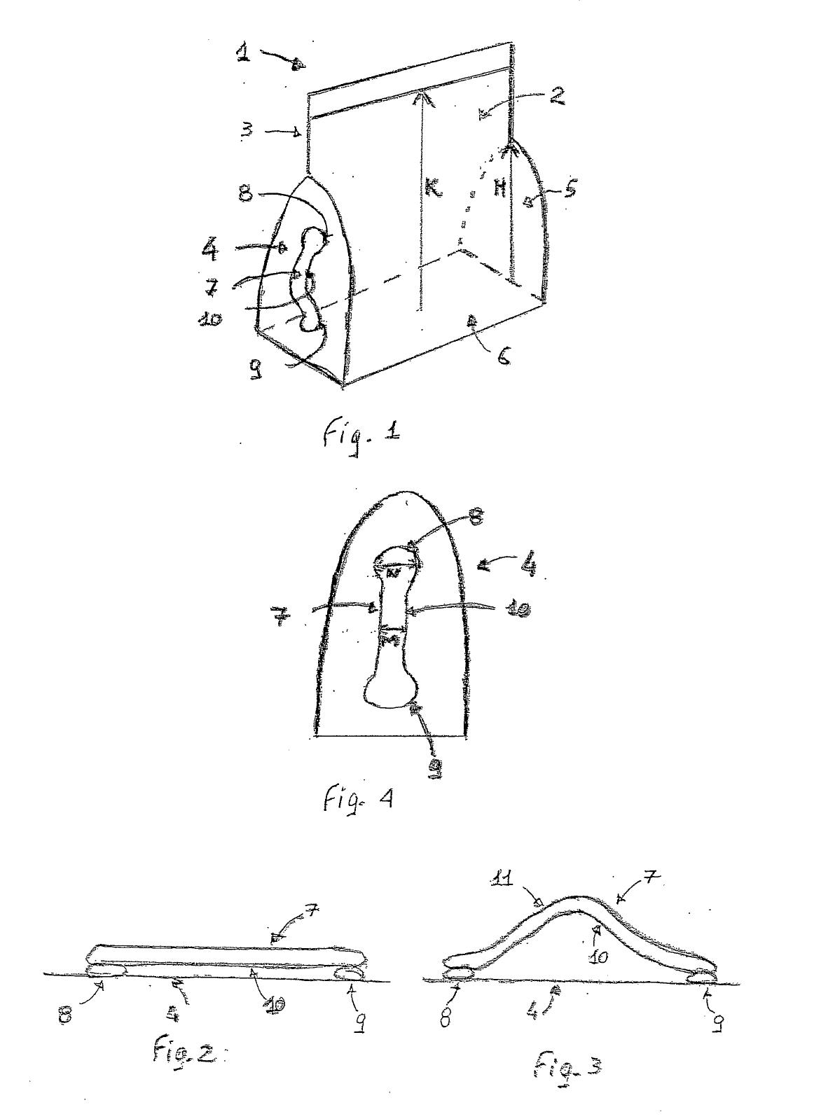

FIG. 4 is a plan view of a preferred embodiment of a device suitable for forming a handle of a container of the present invention;

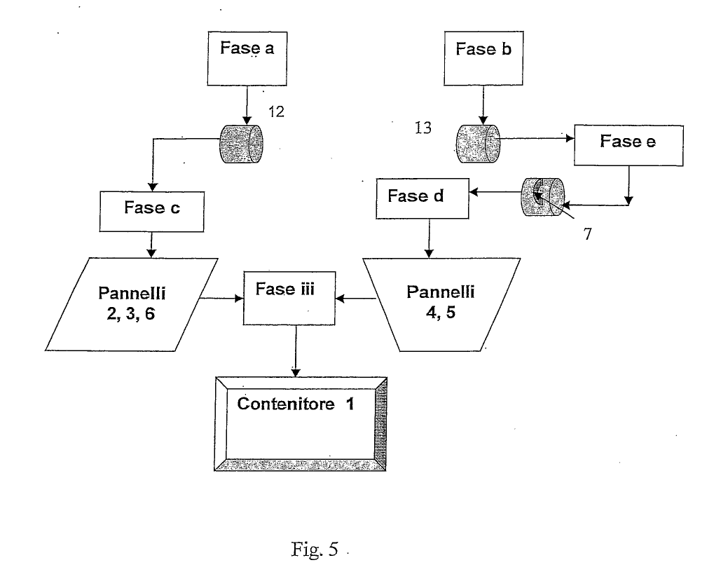

FIG. 5 is a schematic representation of a preferred embodiment of the method for producing the container according to the invention.

With reference to FIG. 1, the container 1 according to the present invention is shown, made with plastic material and consisting of a first front panel 2, a second front panel 3, a first side panel 4, a second side panel 5 and a bottom panel 6, all of said panels being sealed together to form the airtight container 1. From such a FIG. 1 it is clear that the length H of the side panels (4,5) is lower than the length K of the front panels (2,3).

The device 7, consisting of multi-layer plastic material, is applied by means of adhesive onto the side panel 4. The device 7 comprises, in the bottom layer, i.e. the one that adheres to the surface of the side panel 4, two adhesion areas (8,9) comprising an adhesive suitable for ensuring an adhesion force between the device 7 and the side panel 4 itself on which they are applied. In between such adhesion areas (8,9) there is a non-adhesion area 10 that allows the device 7 to be partially raised in the operative step to form a handle 11, which can be gripped, thus allowing the container 1 to be transported, without breaking or tearing.

For the sake of clarity, with reference to FIGS. 2 and 3, it is possible to see the two different positions of the device 7: in fact, a first rest position can be seen in FIG. 2, wherein the device 7 adheres to the outer surface of the side panel 4 onto which the device 7 is applied. Therefore, in this rest position, the device 7 does not create any bulk and therefore makes it easier to fill and close the container 1 when it is inserted into filling machines and thereafter stored.

Vice-versa, in FIG. 3 it is possible to see the device 7 in the second operative position, i.e. when the device 7 is raised at the non-adhesion area 10 so as to form the handle 11, suitable for being gripped to transport the container 1.

FIG. 4 shows a preferred embodiment of a device 7 suitable for forming a handle 11 for the container 1 according to the present invention, wherein the width M of the device 7 in the non-adhesion area 10 is lower than the width N of the adhesion areas (8,9). The resulting “bone” shape of the device 7 ensures that the device 7 itself is easy to grip at the non-adhesion area 10 in the operative step and ensures a good adhesion force with the side panel 4 in the adhesion areas (8,9), avoiding the risk of the container 1 tearing at the moment when the device 7 is raised in the operative step.

With reference to FIG. 5, a preferred embodiment of the method for producing the container 1 of the present invention is shown schematically.

By means of techniques known in the art (and thus not described in details herein), a reel of a main multi-layer laminate 12 made from flexible plastic material is prepared, step a). Similarly, a reel of a secondary multi-layer laminate 13 made from flexible plastic material is prepared, step b).

The main laminate 12 thus prepared in step a) is cut, folded and sealed along the edges carrying out transversal and longitudinal welding between overlapping parts of heat-sealable layers to form the front panel 2, the front panel 3 and the bottom panel 6 of the container 1 (step c).

The reel of secondary laminate 13 is unwound and the adhesive device 7 is applied onto a portion of it through an applicator (step e).

Following such a step e), the secondary laminate 13, thus having the adhesive device 7 applied onto a portion of it, is cut, folded and sealed along the edges carrying out transversal and longitudinal welding between overlapping parts of heat-sealable, layers to form the side panel 4, containing the device 7, and the side panel 5 of the container 1 (step d).

Thereafter (step iii), the front panel 2, the front panel 3 and the bottom panel 6 (obtained at the end of step c) are thus sealed with the side panel 4 (containing the device 7) and the side panel 5 (obtained at the end of step d) to obtain the container 1 according to the present invention.

The above described preferred embodiment of the method according to the present invention for producing such a container 1 is therefore efficient and cost-effective. In particular, step e) of application of the device 7 involves just a part of the entire production cycle of the container 1, without having to make modifications to the remaining part of such a cycle and without any further costly application of the device at the end of the production of the container 1 itself.

Of course, the above described embodiments must be understood to be mere non-limiting illustrations of some possible embodiments of the container of the present invention and of the method for producing it, being clearly understood that any element relating to the container and to the method for producing it can be varied by the man skilled in the art in order to satisfy specific and contingent requirements, whilst still being covered by what is claimed.

For example, the step of application of the device 7 (step e) to the secondary laminate 13 could be carried out during step b) of preparation of the second reel of secondary laminate 13, by introducing the suitable apparatus in the lamination or cutting step.

1. A container suitable for being subjected to a filling and closing process, said container being formed from at least one flexible multi-layer laminated film and comprising: at least one front panel and at least one side panel sealed together, the length of said at least one side panel being shorter than the length of said at least one front panel, said container comprising at least one device applied with adhesive to the outer surface of at least one of said side panels, said device being suitable for being partially raised to form a handle for the container itself.

2. The container according to claim 1, wherein said device comprises at least one adhesion area and a non-adhesion area to said outer surface of said side panel.

3. The container according to claim 2, wherein said non-adhesion area is located between two of said adhesion areas.

4. The container according to claim 3, wherein the width of said device in said non-adhesion area is lower than the width of said adhesion areas.

5. The container according to claim 1, wherein said at least one side panel on which said device is applied to comprise an “-adhesion promoter on its outer surface.

6. The container according to claim 1, wherein said device comprises at least one adhesion area to said outer surface of said side panel and wherein said outer surface of said side panel comprises a non-adhesion area.

7. A method for producing a container as described in claim 1, wherein said method comprises the steps of:
i) preparing at least one flexible multi-layer laminate;
ii) forming at least one front panel and at least one side panel from said at least one laminate;
iii) forming said container by sealing together said at least one front panel and said at least one side panel, wherein before said step ii) begins, an adhesive device is applied to a portion of said at least one laminate suitable for forming said at least one side panel.

8. The method according to claim 7, wherein said step ii) further comprises the formation of at least one bottom panel.

9. The method according to claim 7, wherein said step i) comprises the independent steps of:
a) preparing a main flexible multi-layer laminate, and
b) preparing a secondary flexible multi-layer laminate.

10. The method according to claim 9, wherein said step ii) comprises the steps of: c) forming at least one front panel from said main laminate, and d) forming at least one side panel from said secondary laminate.

11. The method according to claim 10, wherein said step c) further comprises the formation of at least one base panel from said main laminate.

12. The method according to claim 7, wherein said step iii) comprises the formation of said container by sealing together two front panels, two side panels and a bottom panel.

13. The method according to claim 7, wherein said adhesive device is applied to said secondary laminate during step b).

14. The method according to claim 7, wherein said adhesive device is applied to said secondary laminate in an additional process step following step b) and prior to step d).

15. A method of assembling a flexible container comprising:
providing two front panels of a multi-layer laminate;
providing two reduced gusset side panels of a multi-layer laminate;
next adhering a handle to an outer face of said reduced gusset side panels;
next assembling said front panels and said side panels to position said adhered handle to be clear of filling apparatuses when filling an assembled flexible container, and to position said adhered handle to be clear of closing a top of said assembled flexible container.

16. The method of claim 15, wherein said side panels are provided as wound rolls, individual side panels being cut from said roll after said step of adhering said handle.
